(19) United States
(12) Patent Application Publication
(10) Pub. No.: US 2006/0032047 A1
(43) Pub. Date: Feb. 16, 2006

(54) Connector filler element insertion tool and method

(75) Inventor: Gerald M. Johnson, Stanwood, WA (US)

Correspondence Address: BAKER & HOSTETLER LLP, Washington Square, Suite 1100, 1050 Connecticut Avenue, N.W., WASHINGTON, DC, 20036, US

(73) Assignee: The Boeing Company

(21) Appl. No.: 10/915,368

(22) Filed: Aug. 11, 2004

(51) Int. Cl. H01R 43/20

(52) U.S. Cl. 29/747; 29/876

(57) ABSTRACT

An apparatus for inserting filler elements such as sealing plugs within electrical connectors includes a threaded connector, a serrated grip, an ergonomic handle and a hollow tube for receiving filler elements of various sizes. The hollow tube assembly may be interchangeable with variously sized hollow tubes to accommodate the various sized filler elements.

### FIELD OF THE INVENTION

The present invention relates generally to electrical connectors. More particularly, the present invention relates a tool for inserting sealing plugs into electrical connectors.

### BACKGROUND OF THE INVENTION

Bundles of wires carrying multiple signals are usually connected to other similar bundles or interfaced to devices such as instruments and control mechanisms through the use of electrical connectors into which contacts corresponding to the individual wires of the bundles are assembled. The connectors allow leads from the wires to be brought into an orderly mating relationship with conductive leads from other wire bundles, instruments, or control mechanisms.

It is conventional for a connector to comprise a pair of cylindrical shells which are adapted for fitting together in a single prescribed manner. Each such shell includes a contact receiving insert. Each insert is made of a dielectric material and is in the form of a plate having an inner surface which is intended to confront the other insert within the connector and an opposite outer surface which is parallel to the inner surface. Numerous holes penetrate the inserts opening at their opposite ends to the inner and outer surfaces of the inserts.

A wire is prepared for attachment to the connector by stripping the dielectric sleeve from the end of the wire so as to expose its conductive core and crimping a contact onto the conductor. This contact may be in the form of either a pin or a socket receptacle. The contact is introduced into a hole in an insert by way of the outer surface thereof and, in the case of a pin, projects beyond the inner surface of the insert. When all the wires have been attached to their respective inserts and the inserts are brought together, the contacts that are received in the holes of one insert are physically engaged by the contacts that are received in the holes of the matching insert within the connector.

In many cases, the number of holes within connectors turns out to be greater than the number of wires to be attached thereto. For many applications, the connector must be sealed by filling the unused holes with filler elements of a non-conductive material, e.g., to prevent unwanted air leaks.

Presently, sealing plugs are inserted with an insertion tool made of plastic. This tool, while generally effective, has some disadvantages. For example, the tool is somewhat hard to use and often requires the use of alcohol for lubrication. The plastic tool also can sometimes break easily. The plastic tool also sometimes damages the connector grommet, requiring replacement.

Other existing tools also are susceptible to breakage and can cause damage. These existing tools are also somewhat slow to use because they are not user-friendly or ergonomic to hold. The potential of damage to electrical connectors is of concern because the connectors can be very expensive. Another matter at hand is that when sealing the unused holes with filler elements, it is required to take great care not to damage any hole grommets or collets with the edges of the insertion tool being used. If damage does occur, then significant downtime may result.

When attaching a breakout or “bundle” of wires from a wiring harness to a particular connector, it is necessary to insure that the contacts and filler elements are located in the proper holes of the insert since otherwise the right circuits will not be completed when it is coupled to its mating insert within the connector.

Accordingly, it is desirable to provide a method and apparatus that is ergonomic in design and durable and safe to use when inserting sealing plugs or filler elements into electrical connectors.

### SUMMARY OF THE INVENTION

The foregoing needs are met, to a great extent, by the present invention. Various embodiments of the present invention provide an improved device for installing filler elements into the electrical connectors, provide an improved tool for the installation of filler rods without damaging the electrical connectors, and/or provide an improved device for installing filler elements of varying sizes to accommodate variously sized electrical connectors as desired.

In one aspect, an apparatus is provided that in some embodiments has a hollow metal tube, with one end inserted in a wooden handle, the other open to receive a sealing plug. It is to be used as an insertion guide to install filler rods or elements (i.e., sealing plugs) into electrical connectors. This provides a method and apparatus that is ergonomic in form and durable and safe to use when inserting sealing plugs into electrical connectors.

In accordance with one aspect of the present invention, a filler element insertion kit for inserting elements into electrical connectors is provided comprising an insertion tool assembly comprising a handle; a threaded grip, wherein the threaded grip is connected to the handle; and a hollow tube connected to the threaded grip and configured to receive a filler element, wherein the hollow tube and threaded grip are part of a set of interchangeable hollow tubes and threaded grips.

In accordance with another aspect of the present invention, a method of inserting elements into an electrical connector is provided comprising loading a filler element into an insertion device; aligning the loaded insertion device with a grommet opening within the electrical connector; inserting and unloading the filler element into the grommet opening with the insertion device; and removing the unloaded insertion device from the grommet opening leaving the filler element to seal the grommet opening, wherein the insertion device has a hollow tube sized to fit the filler element in a sliding fit.

In accordance with still another aspect of the present invention, a filler element insertion kit for inserting elements into electrical connectors is provided comprising means for loading a filler element into an insertion device; means for aligning the loaded insertion device with a grommet opening within the electrical connector; and means for inserting and unloading the filler element into the grommet opening with the insertion device.

There has thus been outlined, rather broadly, certain embodiments of the invention in order that the detailed description thereof herein may be better understood, and in order that the present contribution to the art may be better appreciated. There are, of course, additional embodiments of the invention that will be described below and which will form the subject matter of the claims appended hereto.

In this respect, before explaining at least one embodiment of the invention in detail, it is to be understood that the invention is not limited in its application to the details of construction and to the arrangements of the components set forth in the following description or illustrated in the drawings. The invention is capable of embodiments in addition to those described and of being practiced and carried out in various ways. Also, it is to be understood that the phraseology and terminology employed herein, as well as the abstract, are for the purpose of description and should not be regarded as limiting.

As such, those skilled in the art will appreciate that the conception upon which this disclosure is based may readily be utilized as a basis for the designing of other structures, methods and systems for carrying out the several purposes of the present invention. It is important, therefore, that the claims be regarded as including such equivalent constructions insofar as they do not depart from the spirit and scope of the present invention.

### BRIEF DESCRIPTION OF THE DRAWINGS

FIG. 1 is an exploded view illustrating an insertion tool according to a preferred embodiment of the invention.

FIG. 2 is a side view of the insertion tool.

FIG. 3 is a side view of a hollow tube with a filler element.

FIG. 4 is an axial view of the filler element.

FIG. 5 is a side view of the sealing plug of FIG. 4.

FIG. 6 shows a plan view of a set of the filler elements according to a preferred embodiment of the invention.

FIG. 7 shows a plan view of a set of hollow tubes associated with the set of filler elements of FIG. 6.

FIGS. 8-10 illustrate a preferred embodiment of the invention in use with an electrical connector.

### DETAILED DESCRIPTION

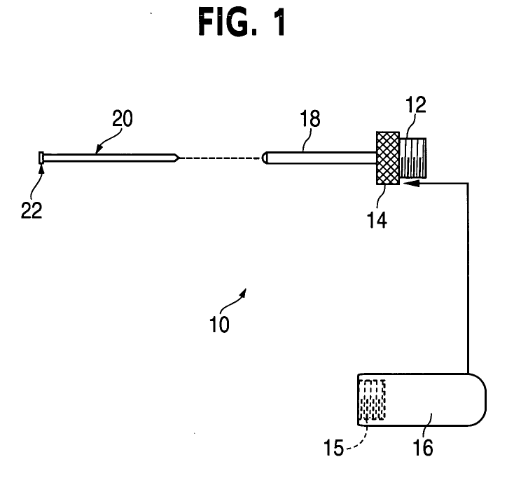

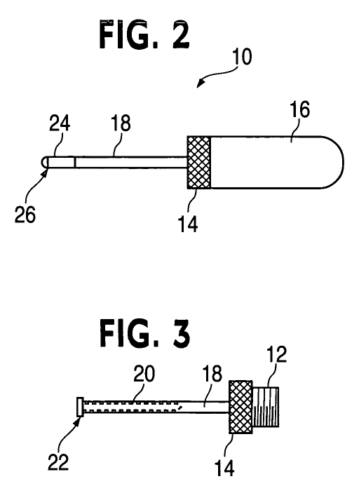

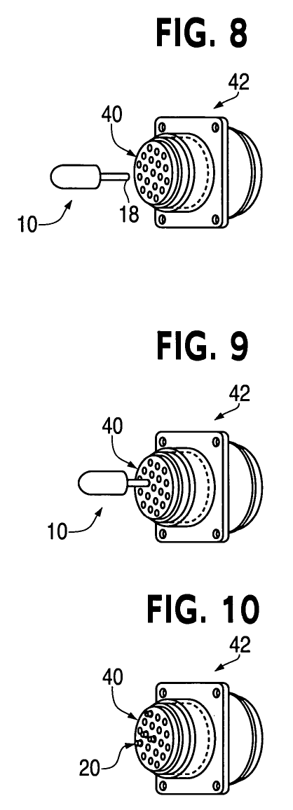

The invention will now be described with reference to the drawing figures, in which like reference numerals refer to like parts throughout. Referring to FIGS. 1 and 2, an embodiment in accordance with the present invention provides an insertion tool 10 used to insert filler elements 20 (preferably made of plastic) into the unused cavities or holes of a grommet 40 in an electrical connector 42 otherwise occupied by a pin or socket as shown in FIGS. 8-10. These filler elements 20 are called “filler rods” or “sealing plugs” and the insertion tool 10 used to insert them is different than the tool used to insert (or remove) a pin/socket.

Referring to FIG. 2, the present invention includes a hollow tube 18 attached to an ergonomic handle 16. Preferably, the hollow tube 18 is made of steel. The hollow tube 18 may be connected or integral to a threaded connector 12 having a serrated grip 14. The threaded connector 12 may be screwed into the threaded portion 15 of ergonomic handle 16 accordingly.

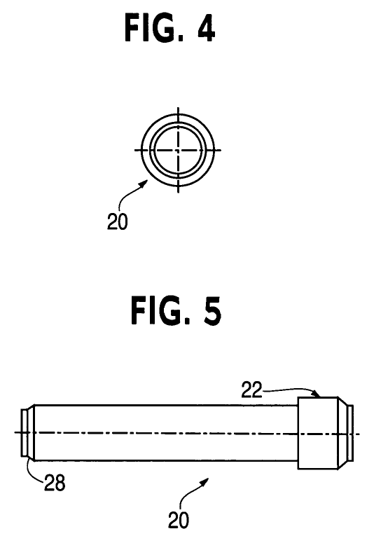

Referring to FIGS. 3-5, the inner diameter of the hollow tube 18 is substantially the same as the outer diameter of the body of the filler element or sealing plug 20 as measured within an appropriate tolerance such as, e.g., thousandths of an inch. This tolerance with allow the filler element or sealing plug 20 to freely slide within the hollow tube 18 but without any major slack. The outer diameter of the hollow tube 18 is substantially the same as the diameter of the head of the plug 22 which may have a chamfered end 28 to facilitate its insertion into openings of grommet 40. The hollow tube 18 may have a tapered end portion 24 with a beveled tip 26 in order to better facilitate the insertion of filler element or sealing plug 20 into a grommet 40 or other opening safely.

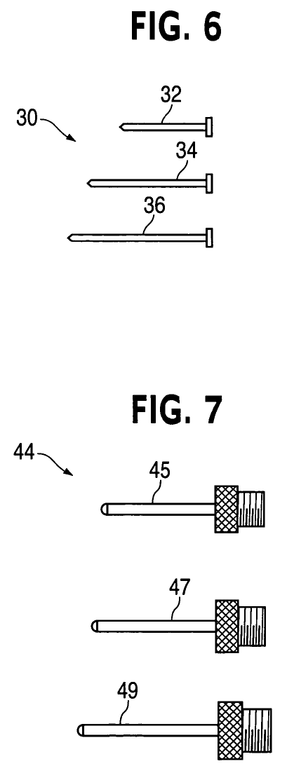

Referring to FIG. 6, sealing plugs or filler elements 20 come in different sizes as shown by filler element set 30. For example, sealing plug 32 is a 20-1 size plug, sealing plug 34 is a 16-1 size plug, and sealing plug 36 is a 12-1 size plug and the tool hollow tube 18 may be configured to accommodate variously sized filler elements or sealing plugs 20 as in the described filler element set 30. The insertion tool 10 is hollow for the entire length of the hollow tube 18 as shown in FIG. 3.

Referring to FIG. 7, the hollow tube 18 may be different sizes as shown by hollow tube connector set 44. For example, a hollow tube 45 may fit a 20-1 size sealing plug, a hollow tube 47 may fit a 16-1 size sealing plug, and a hollow tube 49 may fit a 12-1 size sealing plug accordingly. It should also be noted that a 22-1 sealing plug, an 8-1 sealing plug, a 4-1 sealing plug or a 0-1 sealing plug size may also be used if needed with an appropriately sized hollow tube. The handle 16 or hollow tube 18 may have a color which matches the filler elements or sealing plugs 20 color.

In operation, referring to FIGS. 8-10, the insertion tool 10 would be loaded with a predetermined sized filler element or sealing plug 20 appropriate for the electrical connector grommet 40. The user would then align the insertion tool 10 with the grommet openings to be filled or sealed and a filler element or sealing plug 20 is inserted within the opening for a sliding fit. Again, it should be noted that the filler elements or sealing plugs 20 must move or slide out freely from the hollow tube 18 without any major slack. The user would now retract the insertion tool 10 leaving the filler element or sealing plug 20 lodged within the openings of grommet 40 accordingly.

In the instance when a different sized filler element or sealing plug 20 is required, the user may use the interchangeable hollow tube connector set 44 by switching out the appropriately sized hollow tube 45, 47 or 49 as needed with the ergonomic handle 16. For example, a user may switch to the hollow tube 47 to match the 16-1 sealing plug 34 from the filler element set 30 by detaching or unscrewing the present hollow tube connected to the ergonomic handle 16 and attaching or screwing the needed hollow tube 47 to the ergonomic handle 16.

The above steps are repeated until all of the desired grommet openings are filled or sealed. The filler element or sealing plug may be trimmed if desired at this stage.

Although an example of the insertion tool 10 is shown using filler elements or sealing plugs 20, it will be appreciated that other types of filler elements can be used. Also, although the insertion tool 10 is useful to seal electrical connectors it can also be used to seal or fill openings in elements or devices other than electrical connectors 42 in industries that require an insertion tool that may reach tight spots in a safe and secure manner at a relatively low cost.

The many features and advantages of the invention are apparent from the detailed specification, and thus, it is intended by the appended claims to cover all such features and advantages of the invention which fall within the true spirit and scope of the invention. Further, since numerous modifications and variations will readily occur to those skilled in the art, it is not desired to limit the invention to the exact construction and operation illustrated and described, and accordingly, all suitable modifications and equivalents may be resorted to, falling within the scope of the invention.

What is claimed is:

1. A filler element insertion kit for inserting elements into electrical connectors, comprising:
an insertion tool assembly comprising:
a handle;
a threaded grip, wherein said threaded grip is connected to said handle; and
a hollow tube connected to said threaded grip and configured to receive a filler element.

2. The filler element insertion kit of claim 1, wherein said hollow tube and threaded grip are part of a set of interchangeable hollow tubes and threaded grips.

3. The filler element insertion kit of claim 1, wherein said hollow tube is steel.

4. The filler element insertion kit of claim 1, wherein said hollow tube is hollow along its entire length.

5. The filler element insertion kit of claim 1, wherein said hollow tube has a tapered end portion.

6. The filler element insertion kit of claim 5, wherein said hollow tube has a beveled tip along the tapered end portion.

7. The filler element insertion kit of claim 1, wherein the filler element is part of a set of filler elements.

8. The filler element insertion kit of claim 1, wherein said filler element has a chamfered end.

9. The filler element insertion kit of claim 8, wherein said filler element has a head on one end disposed opposite said chamfered end.

10. The filler element insertion kit of claim 9, wherein said head is wider than said hollow tube.

11. The filler element insertion kit of claim 1, wherein said hollow tube is part of a set of hollow tubes.

12. The filler element insertion kit of claim 7, wherein the set of filler elements comprises a filler element from the group consisting of 22-1, 20-1, 16-1, 12-1, 8-1, 4-1 and 0-1 sized filler elements.

13. The filler element insertion kit of claim 11, wherein the set of hollow tubes comprises a hollow tube from the group consisting of 22-1, 20-1, 16-1, 12-1, 8-1, 4-1 and 0-1 sized hollow tubes.

14. A method of inserting elements into an electrical connector, comprising:
loading a filler element into an insertion device;
aligning the loaded insertion device with a grommet opening within the electrical connector;
inserting and unloading the filler element into the grommet opening with the insertion device; and
removing the unloaded insertion device from the grommet opening leaving the filler element to seal the grommet opening.

15. The method of claim 14, wherein the insertion device has a hollow tube sized to fit the filler element in a sliding fit.

16. The method of claim 15, wherein the hollow tube has a tapered end portion configured to receive the filler element.

17. The method of claim 14, wherein the hollow tube is attached to an ergonomic handle.

18. A filler element insertion kit for inserting elements into electrical connectors, comprising:
means for loading a filler element into an insertion device;
means for aligning the loaded insertion device with a grommet opening within the electrical connector; and
means for inserting and unloading the filler element into said grommet opening with the insertion device.

19. The filler element insertion kit of claim 18, wherein the means for loading is a hollow tube portion of the insertion device.

20. The filler element insertion kit of claim 19, wherein the means for aligning is a tapered end portion of the hollow tube portion.

21. The filler element insertion kit of claim 19, wherein the means for inserting and unloading is an ergonomic handle attached to the hollow tube portion.
